(19) United States
(12) Patent Application Publication
(10) Pub. No.: US 2009/0133769 A1
(43) Pub. Date: May 28, 2009

(54) STRUCTURE OF HOSE

(75) Inventors: William Myles Riley, Richmond, VA (US); Stephen Hatcher, Dillsburg, PA (US); Edgar B. Montague, Charlotte, NC (US); Cheng Fu, Tongkong (TW); Karen Richwine, Mechanicsburg, PA (US)

Correspondence Address: ECKERT SEAMANS CHERIN & MELLOTT, 600 GRANT STREET, 44TH FLOOR, PITTSBURGH, PA, 15219, US

(73) Assignee: Ames True Temper, Inc., Camp Hill, PA (US)

(21) Appl. No.: 12/274,671

(22) Filed: Nov. 20, 2008

(30) Foreign Application Priority Data
Nov. 22, 2007 (TW) 96144722

(51) Int. Cl. F16L 11/00

(52) U.S. Cl. 138/122; 138/137; 138/125; 138/132

(57) ABSTRACT

A hose includes at least an inner-layer tubular member, an intermediate layer, and an outer-layer tubular member. Both the inner-layer tubular member and the outer-layer tubular member are made of plastics. The intermediate layer is formed by wrapping a net. An outer surface of the intermediate layer is provided with a helical structure made of plastics and the outer-layer tubular member encloses the helical structure. The helical structure has a mechanical strength greater than the outer-layer tubular member. Since both the helical structure and the outer-layer tubular member are similarly made of plastics, the bonding strength therebetween can be enhanced. When the hose is subjected to bending, the helical structure helps to prevent the hose from being compressed and deformed, thereby maintaining the inside diameter of the hose to ensure smooth flow of liquid or gas through the hose.

### BACKGROUND OF THE INVENTION

1. Technical Field of the Invention

The present invention relates to a structure of a hose, and in particular to a hose structure that comprises a plastics-made helical structure embedded in an outer tubular member thereof for resisting compression and deformation of the hose caused by bending.

2. Description of the Prior Art

As shown in FIGS. 1 and 2, a conventional hose, generally designated at 1, comprises an inner layer 11, an intermediate layer 12, and an outer layer 13. The inner layer 11 is a hollow tubular body made of plastics and has an outer surface wrapped with a net that forms the intermediate layer 12. The intermediate layer 12 has an outer surface that is wrapped with the outer layer 13. The outer layer 13 is similarly made of plastics. The conventional hose 1 comprises the intermediate layer 12 wrapped around the outer surface of the inner layer 11 and the net of the intermediate layer 12 functions to effectively enhance the compression resistance of the hose 1. However, as shown in FIG. 3, when the hose 1 is bent with excessively small radii of curvature or is excessively twisted, corruption, cracking or even breaking may be resulted. When the hose 1 undergoes deformation due to the corruption or compression, the inside diameter of the hose 1 is reduced, leading to blocking of the liquid or gas flowing through the hose 1. In case of cracking or breaking, leakage of the liquid or gas delivered through the hose 1 may occur.

A hose structure with enhanced flexibility for overcoming the above problems is available in the market. FIG. 4 shows such a hose, which is designated at 2, comprising an inner layer 21, an intermediate layer 22, and an outer layer 23. The inner layer 21 is a hollow tubular body made of plastics and has an outer surface wrapped with a net that forms the intermediate layer 22. The intermediate layer 22 has an outer surface on which a reinforcement structure 24 is provided. The reinforcement structure 24 is in the form of thin wires made of metal circumferentially surrounding the outer surface of the intermediate layer 22. The reinforcement structure 24 is enclosed and surrounded by the outer layer 23. The outer layer 23 is made of plastics. Although the conventional hose 2 exhibits improved flexibility due to the reinforcement structure 24, which effectively eliminates the problem of reduction of inside diameter of the hose 2 due to being subjected to compression, yet the metal reinforcement structure 24 and the plastic outer layer 13 are made of different materials, and this leads to poor bonding therebetween. Further, when the outer layer 13 undergoes weathering that leads to aging and cracking, the interior reinforcement structure 24 may get exposed to the surrounding atmosphere, leading to corrosion of the reinforcement structure 24. Further, when the hose 2 is subjected compression that goes beyond the metal strength of the reinforcement structure 24, the reinforcement structure 24 may still get deformed, similarly leading to corruption of the hose 2.

In view of the above discussed problems of the conventional hoses, it is desired to have a hose structure that overcomes the drawbacks of corruption, cracking and breaking caused by excessively bending and twisting.

### SUMMARY OF THE INVENTION

An objective of the present invention is to provide a hose that eliminates the potential risks of corruption, cracking and breaking caused by excessively bending and twisting.

In accordance with an aspect of the present invention, a hose is provided, comprising at least an inner-layer tubular member, an intermediate layer, and an outer-layer tubular member. Both the inner-layer tubular member and the outer-layer tubular member are made of plastics. The intermediate layer is formed by wrapping a net. An outer surface of the intermediate layer is provided with a helical structure made of plastics and the outer-layer tubular member encloses the helical structure. The helical structure has a mechanical strength greater than the outer-layer tubular member. Since both the helical structure and the outer-layer tubular member are similarly made of plastics, the bonding strength therebetween can be enhanced. When the hose is subjected to bending, the helical structure helps to prevent the hose from being compressed and deformed, thereby maintaining the inside diameter of the hose to ensure smooth flow of liquid or gas through the hose.

In accordance with another aspect of the present invention, a hose is provided, wherein the outer-layer tubular member is made of clear or transparent plastic materials, and the helical structure has a cross-sectional dimension that is smaller than the wall thickness of the outer-layer tubular member to thereby provide the hose with a smooth and continuous outer surface. The transparent material of the outer-layer tubular member makes the helical configuration of the helical structure observable through the outer-layer tubular member, thereby enhancing the market appealing of the hose product.

In accordance with a further aspect of the present invention, a hose is provided, wherein the outer-layer tubular member, which has an outer surface following a helical configuration of the helical structure to form helical ridges, which facilitate gripping and prevent slipping off.

Many other advantages and features of the present invention will become manifest to those versed in the art upon making reference to the detailed description and the accompanying sheets of drawings in which preferred structural embodiments incorporating the principles of the present invention is shown by way of illustrative examples.

### BRIEF DESCRIPTION OF THE DRAWINGS

FIG. 1 is a perspective view illustrating a conventional hose structure;

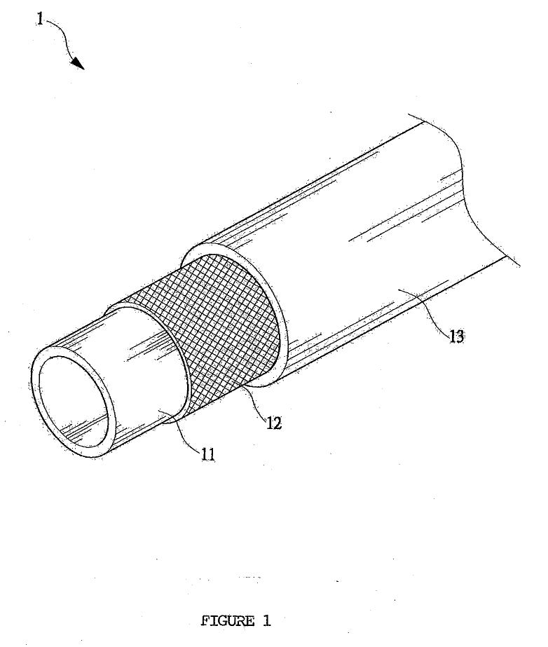

FIG. 2 is a cross-sectional view of the conventional hose structure;

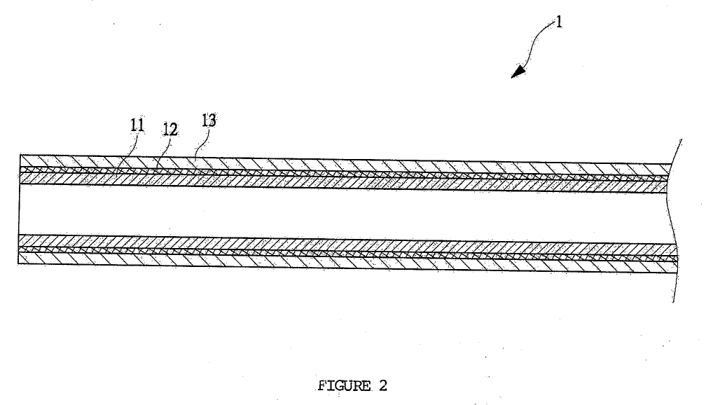

FIG. 3 is a schematic view illustrating deformation of the conventional hose caused by bending;

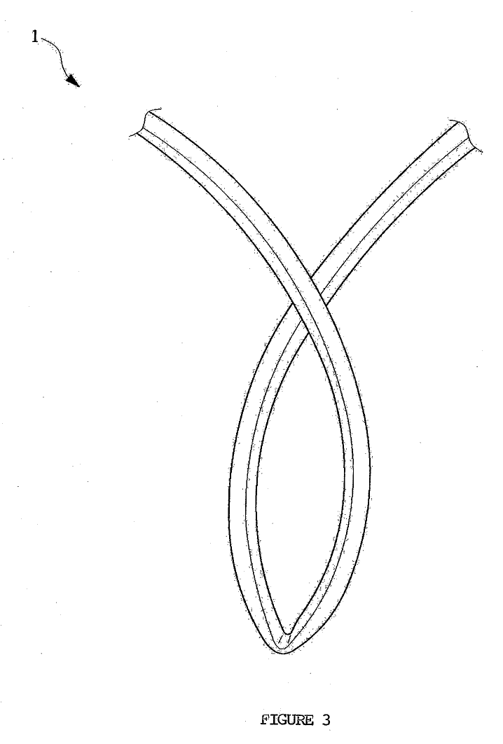

FIG. 4 is a perspective view illustrating another conventional hose structure;

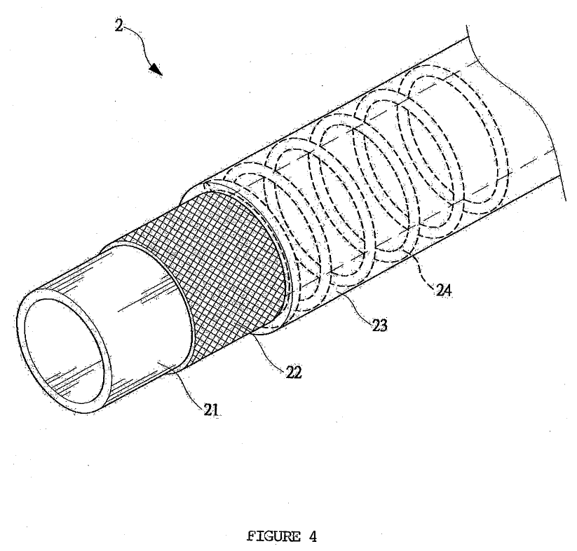

FIG. 5 is a perspective view illustrating a hose constructed in accordance with the present invention;

FIG. 6 is a cross-sectional view of the hose of the present invention;

FIG. 7 is a perspective view illustrating another hose structure in accordance with the present invention; and

FIG. 8 is a cross-sectional view of said another hose structure of the present invention.

### DETAILED DESCRIPTION OF THE PREFERRED EMBODIMENTS

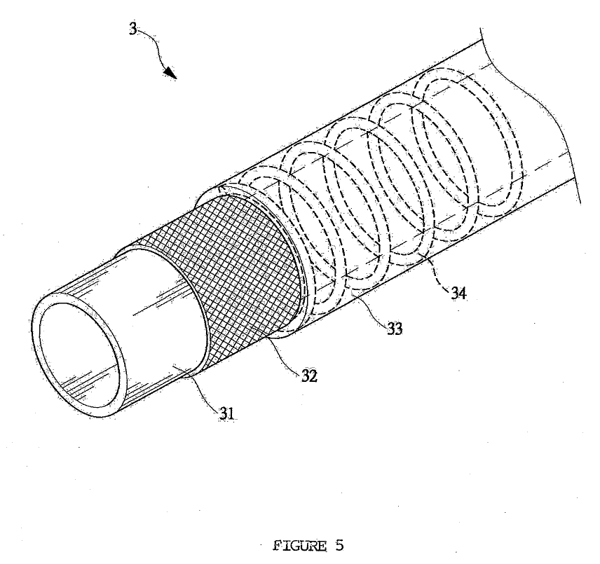

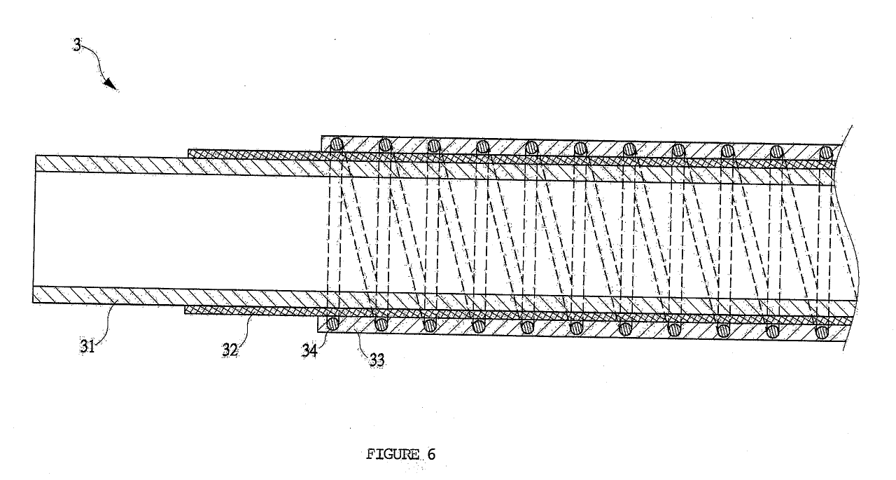

With reference to the drawings and in particular to FIGS. 5 and 6, a hose constructed in accordance with the present invention, generally designated at 3, comprises at least an inner-layer tubular member 31, an intermediate layer 32, and an outer-layer tubular member 33.

The inner-layer tubular member 31 comprises a hollow tubular body made of plastic materials and functions for conveying or conducting a fluid therethrough.

The intermediate layer 32 comprises a layer of gauze or net. The intermediate layer 32 is formed by weaving and wrapping yarns around an outer configuration of the inner-layer tubular member 31 and is further bonded thereto by adhesives so that the intermediate layer 32 and the inner-layer tubular member 31 are securely bonded together. In practice, the yarns that make the net can be made of synthetic fibers, such as nylon, natural fibers, such as cotton, or a mixture of synthetic and natural fibers, such as a mixture of nylon and cotton.

The outer-layer tubular member 33 is made of plastic materials In practice, the outer-layer tubular member 33 can be made of clear or transparent plastics. The outer-layer tubular member 33 is wrapped around an outer surface of the intermediate layer 32.

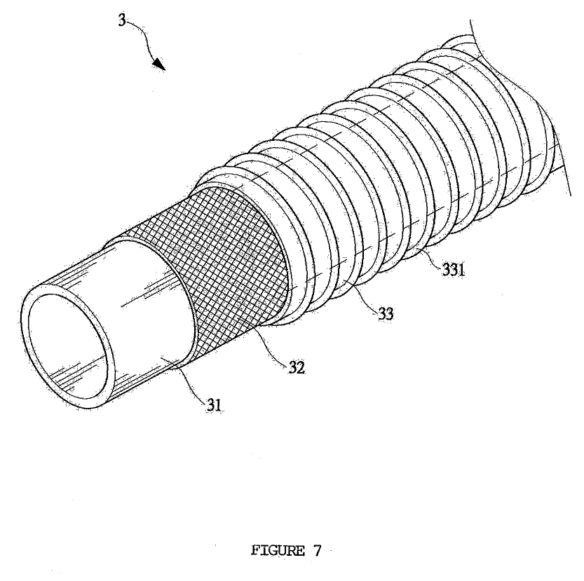

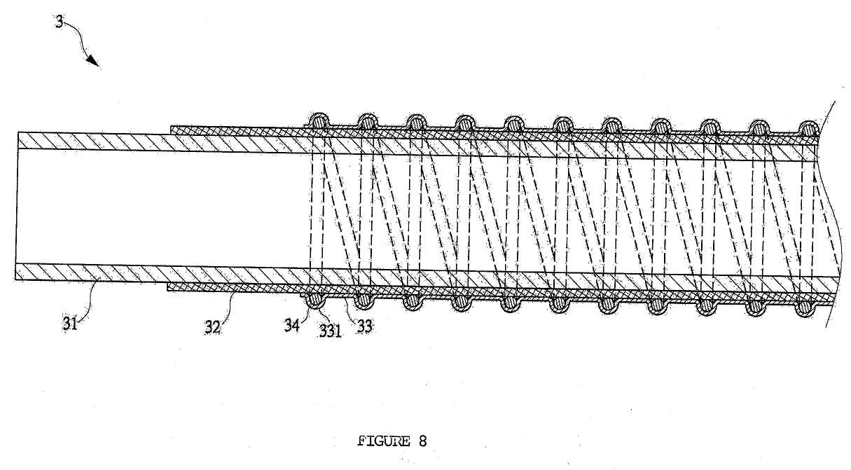

The outer surface of the intermediate layer 32, namely the surface interfacing the outer-layer tubular member 33, is provided with a plastics-made helical structure 34, which has a mechanical strength greater than that of the outer-layer tubular member 33. In practice, the structure 34 may have a cross-sectional diameter that is smaller than the wall thickness of the outer-layer tubular member 33 so that the outer surface of the outer-layer tubular member 33 can be made smooth and continuous. With the outer-layer tubular member 33 being made transparent, the helical pattern exhibiting the structure 34 can show on the outer surface of the hose 3, thereby enhancing the market appealing of the hose 3. Further, also referring to FIGS. 7 and 8, in alternative practice, the outer-layer tubular member 33 can be made in such a way to have an outer configuration that complies the helical configuration of the structure 34 thereby showing a helical raised portion or ridge 331. With such an arrangement, the outer-layer tubular member 33 that surrounds and encloses the helical structure 34 shows the helical ridge 331, which provides the outer surface of the hose 3 with a unsmooth and discontinuous, alternating configuration for facilitating user's holding and preventing slipping of the hose 3.

The present invention integrates the inner-layer tubular member 31, the intermediate layer 32, and the outer-layer tubular member 33 together as a unitary structure and further provides a helical structure 34 between the intermediate layer 32 and the outer-layer tubular member 33. With the structure 34 and the outer-layer tubular member 33 being both made of similar, plastic materials, the bonding strength between the structure 34 and the outer-layer tubular member 33 can be enhanced and reinforcement of the overall strength of the hose 3 as a whole can be realized. Thus, when the hose 3 is subjected to bending of excessively small radii of curvature, the structure 34 incorporated inside the outer-layer tubular member 33 can function to provide enhanced flexibility and strength for resisting reduction of inside diameter of the hose 3 due to compression and deformation caused by local concentration of stress in the hose 3, thereby ensuring smoothness of delivery of liquid or gas through the hose 3. Further, due to the arrangement of the structure 34 in the outer-layer tubular member 33, when the hose 3 is subjected to bending of excessively small radii of curvature due to improper operation or use of the hose 3, if the external force acting on the hose 3 is substantially smaller than the flexible strength of the structure 34, then the strength of the structure 34 is sufficient to spring the hose 3 outward to a condition of large radii of curvature or even restore the hose 3 back to a straight condition with almost no bending, to thereby ensure the function of delivery of the hose 3.

Further, the structure 34 is integrated inside the outer-layer tubular member 33 of the hose. In the case that the cross-sectional dimension of the structure 34 is smaller than the wall thickness of the outer-layer tubular member 33, namely the structure 34 making no projection beyond or raising above the outer surface of the outer-layer tubular member 33, the outer surface, as well as the inner surface, of the outer-layer tubular member 33 is made smooth and continuous. The smooth and continuous inner surface of the outer-layer tubular member 33 ensures that no interference caused thereby with the bonding of the outer-layer tubular member 33 with the intermediate layer 32 and the inner-layer tubular member 31, while the smooth and continuous outer surface of the outer-layer tubular member 33 provides the hose 3 with a smooth outer surface, which exhibits similar advantages of a regular hose that has a smooth outer surface. The transparency of the outer-layer tubular member 33 makes the helical configuration of the structure 34 observable through the outer-layer tubular member 33, leading to enhanced market appealing of the hose 3. In addition, in alternative practice of the outer-layer tubular member 33, the outer-layer tubular member 33 can be made with an outer surface configuration that has helical ridges or raised section 331 following the helical configuration of the structure 34. With such an arrangement, the outer-layer tubular member 33 that surrounds and encloses the helical structure 34 shows a raised pattern of the helical ridge 331, which provides the outer surface of the hose 3 with a unsmooth and discontinuous, alternating configuration for facilitating user's holding and preventing slipping of the hose 3. Thus, the present invention is also advantageous in providing the general consumers with choices of different products.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

What is claimed is:

1. A hose comprising at least an inner-layer tubular member and an outer-layer tubular member, and characterized in that a helical structure made of plastics is arranged between the inner-layer tubular member and the outer-layer tubular member.

2. The hose as claimed in claim 1, wherein the helical structure has a cross-sectional dimension that is smaller than a wall thickness of the outer-layer tubular member.

3. The hose as claimed in claim 1, wherein the helical structure has a mechanical strength that is greater than mechanical strength of the outer-layer tubular member.

4. The hose as claimed in claim 1 further comprising an intermediate layer interposed between the inner-layer tubular member and the outer-layer tubular member.

5. The hose as claimed in claim 4, wherein the intermediate layer comprises a net formed by yarns that are made of a material selected from a group consisting of nylon, cotton, and a mixture of nylon and cotton.

6. The hose as claimed in claim 1, wherein the outer-layer tubular member is made to has an outer surface following a helical configuration of the helical structure to form helical ridges.
